(19) United States
(12) Patent Application Publication
(10) Pub. No.: US 2016/0112658 A1
(43) Pub. Date: Apr. 21, 2016

(54) IMAGE PICKUP APPARATUS

(71) Applicant: CANON KABUSHIKI KAISHA, Tokyo (JP)

(72) Inventor: Takuya Kishi, Kawasaki-shi (JP)

(21) Appl. No.: 14/879,252

(22) Filed: Oct. 9, 2015

(30) Foreign Application Priority Data
Oct. 17, 2014 (JP) 2014-212350

(51) Int. Cl. H04N 5/365; H04N 5/369; H04N 5/225

(52) U.S. Cl. CPC H04N 5/365; H04N 5/2254; H04N 5/369

(57) ABSTRACT

An image pickup apparatus, including: an image pickup element including pixels arranged two-dimensionally; a photoelectric converter arranged for each of the pixels and configured to generate a charge corresponding to incident light amount; a switching unit configured to switch between states of the charge of the photoelectric converter being transferable and not transferable to a charge retainer; a correction data generator configured to read a signal for each pixel from the charge retainer under a state of the charge of the photoelectric converter being not transferable to the charge retainer, to generate noise correction data for each pixel; and a pixel noise corrector configured to read the signal for each pixel from the charge retainer under a state of the charge of the photoelectric converter being transferable to the charge retainer, to thereby correct noise for each pixel based on the noise correction data generated by the correction data generator.

### BACKGROUND OF THE INVENTION

1. Field of the Invention

The present invention relates to an image pickup apparatus configured to pick up an image of a subject by using a solid-state image pickup element.

2. Description of the Related Art

Hitherto, cameras using solid-state image pickup elements of a CCD type, a MOS type, and the like have raised such a problem that fixed pattern noise (FPN) leads to deterioration in image quality. In particular, in a case of a CMOS type and the like, analog signal processing circuits are often formed column by column on a plane of an image pickup element or pixel by pixel in parallel, and a difference in offset level of a signal between respective parallel circuits sometimes appears as the FPN such as vertical stripe noise or pixel unevenness noise.

Owing to the feature of the FPN that the FPN is generated by a certain amount constantly independent of an incident light amount, only the FPN can be acquired when, for example, light entering the image pickup element is blocked to generate a dark image. In Japanese Patent Application Laid-Open No. 2011-228771, there is disclosed a method involving eliminating FPN by using this fact to subtract a short-exposure image from a long-exposure image. In addition, in Japanese Patent No. 5353466, there is disclosed a method involving acquiring FPN by reading a signal under a state in which a charge accumulated in a photoelectric conversion element is not transferred and correcting the FPN by subtracting the signal from a signal read under a state in which the charge is transferred.

However, in the related art disclosed in Japanese Patent Application Laid-Open No. 2011-228771, the short-exposure image needs to be picked up in order to acquire the FPN, and hence an exposure time is reduced by a period of time for temporarily resetting the accumulated charge. In contrast, in the related art disclosed in Japanese Patent No. 5353466, FPN data can be acquired without resetting of the accumulated charge, which can eliminate the vertical stripe noise without reducing the exposure time. However, with this method, the vertical stripe noise can be eliminated, but the FPN existing for each pixel cannot be eliminated.

### SUMMARY OF THE INVENTION

Therefore, an object of the present invention is to provide an image pickup apparatus capable of picking up a satisfactory image by eliminating FPN existing for each pixel without reducing an exposure time.

In order to achieve the above-mentioned object, according to one embodiment of the present invention, there is provided an image pickup apparatus, including: an image pickup element including a plurality of pixels arranged two-dimensionally; a photoelectric converter arranged for each of the plurality of pixels and configured to generate a charge corresponding to an incident light amount; a switching unit configured to switch between a state in which the charge of the photoelectric converter is transferred to a charge retainer and a state in which the charge of the photoelectric converter is not transferred to the charge retainer; a correction data generator configured to read a signal for each of the plurality of pixels from the charge retainer under a state of the charge of the photoelectric converter being not transferrable to the charge retainer, to thereby generate noise correction data for each of the plurality of pixels; and a pixel noise corrector configured to read the signal for each of the plurality of pixels from the charge retainer under a state of the charge of the photoelectric converter being transferrable to the charge retainer, to thereby correct noise for each of the plurality of pixels based on the noise correction data generated by the correction data generator.

According to the image pickup apparatus of the one embodiment of the present invention, it is possible to pick up a satisfactory image by eliminating FPN existing for each pixel without reducing an exposure time.

Further features of the present invention will become apparent from the following description of exemplary embodiments with reference to the attached drawings.

### BRIEF DESCRIPTION OF THE DRAWINGS

FIG. 1 is a block diagram of an image pickup apparatus according to a first embodiment of the present invention.

FIG. 2 is an explanatory diagram for illustrating a circuit within a unit pixel of an image pickup element 2.

FIG. 3 is a flowchart of processing according to the first embodiment.

FIG. 4 is a block diagram of an image pickup apparatus according to a second embodiment of the present invention.

FIG. 5 is a flowchart of processing according to the second embodiment.

### DESCRIPTION OF THE EMBODIMENTS

Exemplary embodiments of the present invention are hereinafter described with reference to the attached drawings.

### First Embodiment

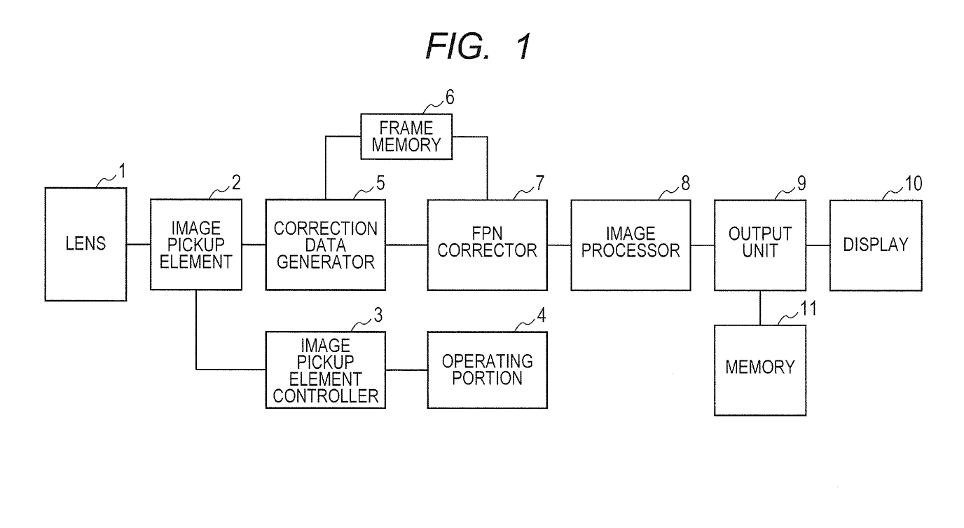

A configuration of a first embodiment of the present invention is described with reference to FIG. 1. An image pickup apparatus according to this embodiment includes a lens 1, an image pickup element 2, an image pickup element controller 3, an operation portion 4, a correction data generator 5, a frame memory 6, an FPN corrector 7, an image processor 8, an output unit 9, and a recording unit 11. A display 10 is connected to the output unit 9.

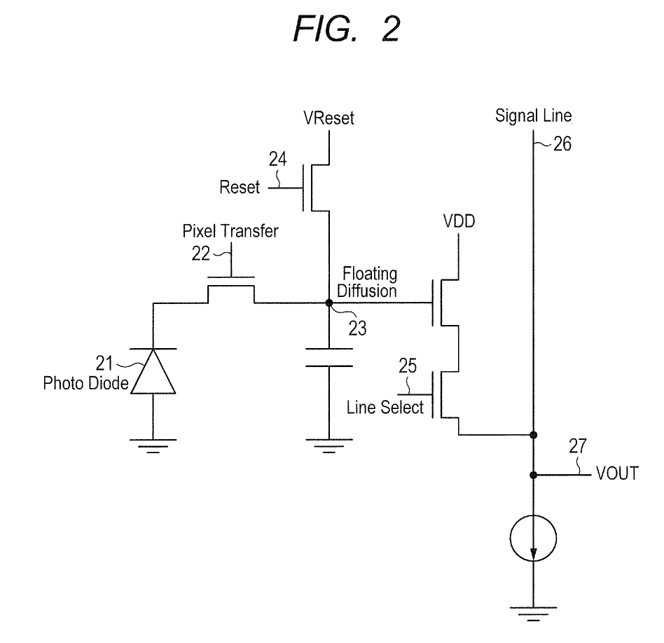

The image pickup element 2 has a structure in which a plurality of pixels configured to receive light from the lens 1 are arranged two-dimensionally. A configuration within a unit pixel of the image pickup element 2 is described with reference to FIG. 2. The unit pixel of the image pickup element 2 includes a photo diode 21, a charge transferring unit (a switching unit) 22, a charge retainer 23, a resetting unit 24, a line selector 25, a vertical signal line 26, and a signal output unit 27. The photo diode (photoelectric converter) 21 is arranged for each pixel, and generates a charge corresponding to an incident light amount.

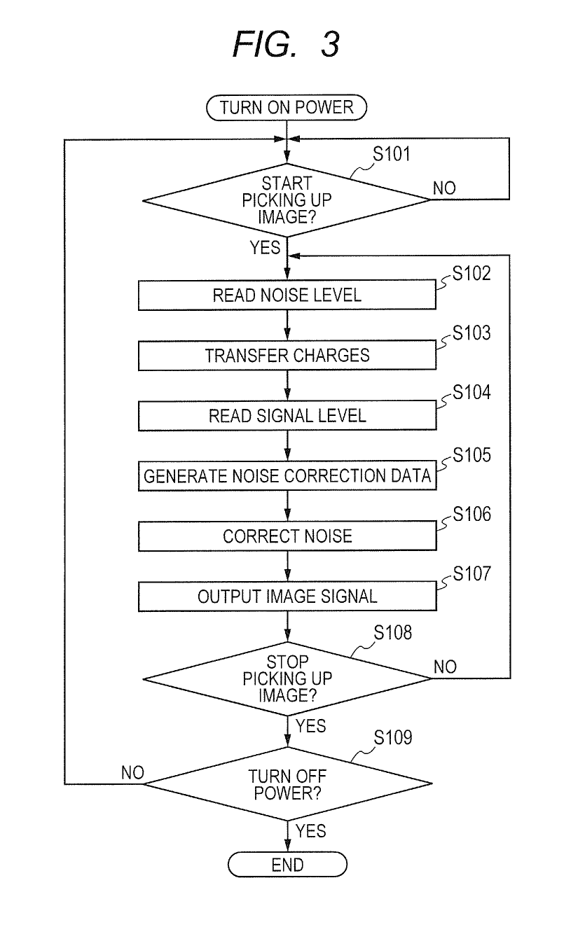

The image pickup apparatus according to this embodiment is a moving image pickup apparatus configured to drive at 60 p (60 frame images are output per second). A flow of image pickup processing according to this embodiment is described with reference to a flowchart of FIG. 3.

After power is turned on, the image pickup apparatus according to this embodiment first determines whether or not an image pickup starting instruction has been input from the operation portion 4 (S101). When the image pickup starting instruction is not input yet, the image pickup apparatus continues a standby status for the image pickup starting instruction. When the image pickup starting instruction is input, the image pickup element controller 3 first starts driving the image pickup element 2, and reads a noise level (S102). The reading of the noise level indicates an operation for reading a level of noise retained in the charge retainer 23 under a state in which the charge transferring unit 22 illustrated in FIG. 2 does not transfer a charge of the photo diode 21. When the reading of the noise level is finished, the image pickup element controller 3 then shifts the charge transferring unit 22 to a state of transferring the charge of the photo diode 21 (S103), to read a signal level (S104). Subsequently, based on the noise level read by the image pickup element 2, the correction data generator 5 generates noise correction data (S105). The noise correction data is obtained by adding and averaging the noise level read in Step S102 for each pixel by 10 most recent frames including the current frame. In other words, based on a plurality of signals acquired by reading the signal a plurality of times, the correction data generator 5 generates the noise correction data for each pixel. The noise correction data and noise level samples corresponding to the 10 frames for generating the noise correction data are stored in the frame memory (memory) 6 illustrated in FIG. 1. After the noise correction data is generated, the FPN corrector (pixel noise corrector) 7 corrects the noise by subtracting, from the signal level read in Step S104, a value of the noise correction data calculated for the same pixel as the pixel whose signal level has been read (S106). Then, the output unit 9 outputs the signal subjected to the noise correction processing to the display 10 and the recording unit 11 as an image signal (S107). When the outputting of the image signal is finished, the image pickup apparatus determines whether or not an image pickup stopping instruction has been input from the operation portion 4 (S108). When the image pickup stopping instruction is not input yet, the image pickup apparatus returns to the processing of Step S102, to continue the moving image pickup. When the image pickup stopping instruction is input, the image pickup apparatus further determines whether or not an instruction to turn off the power has been input (S109). When the instruction to turn off the power is not input yet, the image pickup apparatus returns to the standby status for the image pickup starting instruction in Step S101. When the instruction to turn off the power is input, the power is turned off to end the image pickup apparatus.

As described above, the image pickup apparatus according to this embodiment reads the noise level and the signal level by switching whether or not the charge of the photo diode 21 is transferred by the charge transferring unit 22, which allows the noise correction data to be obtained without reduction of an exposure time. In addition, the image signal is output by generating the noise correction data for each pixel and subtracting the noise correction data from the signal level of the corresponding pixel, which can eliminate not only vertical stripes but also fixed pattern noise ascribable to a difference in offset level for each pixel. Further, the reading of the noise level can be controlled for each pixel, which can set a pixel to be subjected to signal reading for generating the noise correction data and a pixel not to be subjected to the signal reading in an arbitrary region on the image pickup element.

The image pickup apparatus according to this embodiment is assumed as the moving image pickup apparatus driven at 60 p, but may be driven at an image pickup frame rate other than 60 p, or may be applied to a still image pickup apparatus instead of the moving image pickup apparatus. Further, a system configuration and a circuit configuration are not limited to the configurations of this embodiment. For example, the lens 1, the image pickup element 2, the image pickup element controller 3, the operation portion 4, the correction data generator 5, the frame memory 6, the FPN corrector 7, the image processor 8, the output unit 9, and the recording unit 11 that form the image pickup apparatus according to the embodiment of the present invention may be integrally configured, but do not always need to be integrally configured. The above-mentioned components may be configured as a plurality of devices in a divided manner so as to be connected to each other.

### Second Embodiment

Hereinafter, a second embodiment of the present invention is described.

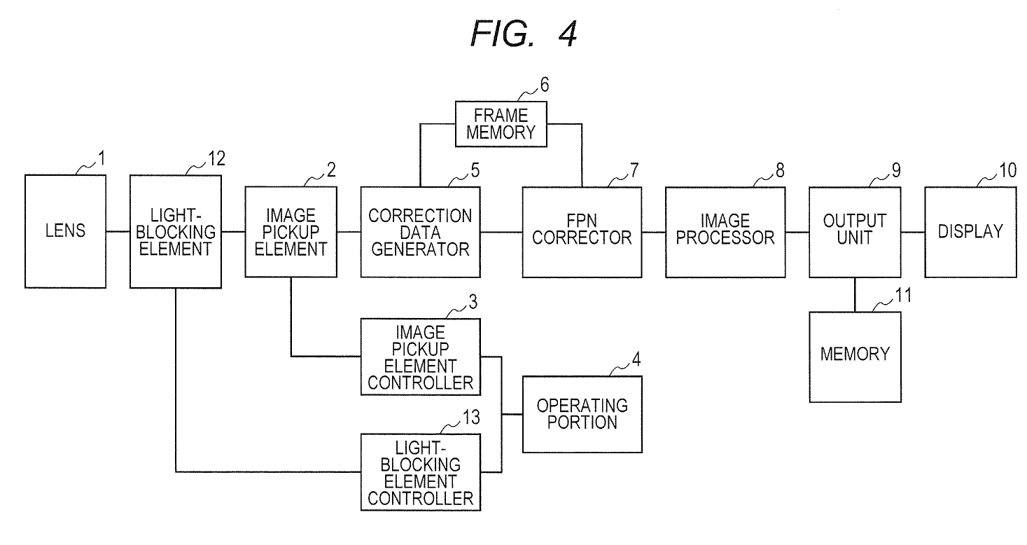

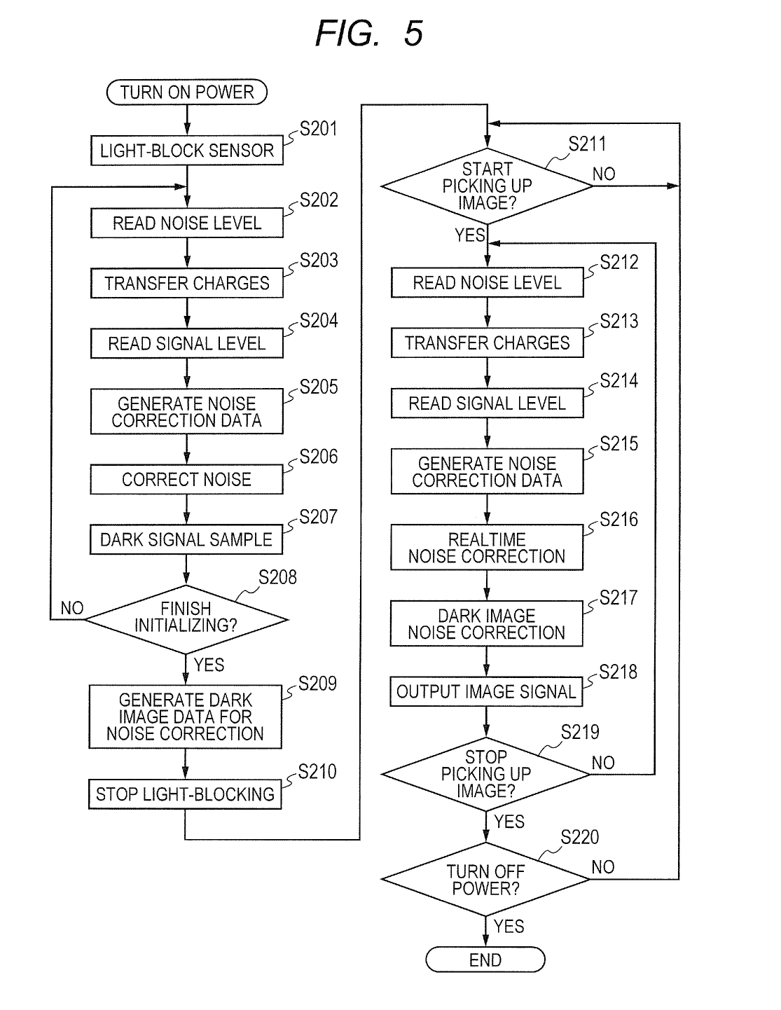

A configuration of this embodiment is illustrated in FIG. 4. A light-blocking element 12 and a light-blocking element controller 13 are added to the configuration of the first embodiment illustrated in FIG. 1. The other components are the same as those of the first embodiment. An image pickup apparatus according to this embodiment is a moving image pickup apparatus driven at 60 p (60 frame images are output per second) in the same manner as in the first embodiment. The flowchart for illustrating the flow of the processing is partially changed, and hence a flow of image pickup processing according to the second embodiment is described with reference to a flowchart of FIG. 5.

The light-blocking element 12 is a member configured to switch between a state of blocking light entering the image pickup element 2 from the lens 1 and a state of allowing the entrance of the light, and the light-blocking element controller 13 is a controller configured to control driving for switching the light-blocking element 12 between the state of blocking the light and the state of allowing the entrance of the light.

After the power is turned on, the image pickup apparatus according to this embodiment conducts initialization processing in order to generate dark image data for FPN correction. First, the light-blocking element controller 13 drives the light-blocking element 12 to block the light entering the image pickup element 2 (S201). A flow of dark image acquisition in Step S202 to Step S206 is the same as the flow of the processing of Step S102 to Step S106 illustrated in the flowchart of FIG. 3. The FPN corrector (dark image data generator) 7 stores a dark signal sample subjected to the noise correction processing into the frame memory 6 (S207). Subsequently, the image pickup apparatus determines whether or not acquisition of dark signal samples by the number necessary to generate dark image data for noise correction is completed to finish the initialization (S208). When the initialization is not to be finished, the image pickup apparatus returns to Step S202 to repeat the operation for sampling a dark signal. When the initialization is to be finished, the FPN corrector 7 sets an average value of the acquired dark signal samples as the dark image data for noise correction, and stores the dark image data into the frame memory 6 (S209). Subsequently, the light-blocking element controller 13 drives the light-blocking element 12 to cancel the light-blocking of the image pickup element 2 (S210), and the image pickup apparatus shifts to a normal moving image pickup flow. In the flow of the processing within the moving image pickup, Step S211 to Step S215 are the same as Step S101 to Step S105 illustrated in the flowchart of FIG. 3. After that, the image pickup apparatus uses the noise correction data generated in Step S215 to correct the noise in real time (the same processing as in Step S106), and further uses, for the obtained image signal, the dark image data for noise correction generated in Step S209 to correct dark image noise (S217). Then, the output unit 9 outputs the signal subjected to the noise correction processing to the display 10 and the recording unit 11 as the image signal (S218). When the outputting of the image signal is finished, the image pickup apparatus determines whether or not the image pickup stopping instruction has been input from the operation portion 4 (S219). When the image pickup stopping instruction is not input yet, the image pickup apparatus returns to the processing of Step S212, to continue the moving image pickup. When the image pickup stopping instruction is input, the image pickup apparatus further determines whether or not the instruction to turn off the power has been input (S220). When the instruction to turn off the power is not input yet, the image pickup apparatus returns to the standby status for the image pickup starting instruction in Step S211. When the instruction to turn off the power is input, the power is turned off to end the image pickup apparatus.

As described above, the image pickup apparatus according to this embodiment reads the noise level and the signal level by switching whether or not the charge of the photo diode 21 is transferred by the charge transferring unit 22, which allows the noise correction data to be obtained without reduction of the exposure time. In addition, the image pickup apparatus uses the dark image data for noise correction acquired in the initialization processing to correct the dark image noise, to thereby allow the FPN existing for each pixel to be corrected more accurately than in the configuration of the first embodiment. In addition, the image signal is output by generating the noise correction data for each pixel and subtracting the noise correction data from the signal level of the corresponding pixel, which can eliminate not only the vertical stripes but also the fixed pattern noise ascribable to the difference in offset level for each pixel. Further, the reading of the noise level can be controlled for each pixel, which can set the pixel to be subjected to the signal reading for generating the noise correction data and the pixel not to be subjected to the signal reading in the arbitrary region on the image pickup element.

The image pickup element may include, in a partial region thereof, a light-blocked pixel shielded from light in order to avoid incident light, and the image pickup apparatus may be configured to combine the noise correction for each pixel according to the embodiment of the present invention with a related-art correction technology such as correction for image signals of pixels in the same column or correction for image signals of each color based on the dark signal that is the image signal output from the light-blocked pixel.

The image pickup apparatus according to this embodiment is assumed as the moving image pickup apparatus driven at 60 p, but may be driven at an image pickup frame rate other than 60 p, or may be applied to a still image pickup apparatus instead of the moving image pickup apparatus so that the effects of the present invention can be obtained. Further, the system configuration and the circuit configuration are not limited to the configurations of this embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or mere circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-212350, filed Oct. 17, 2014, which is hereby incorporated by reference herein in its entirety.

What is claimed is:

1. An image pickup apparatus, comprising:
an image pickup element comprising a plurality of pixels arranged two dimensionally;
a photoelectric converter arranged for each of the plurality of pixels and configured to generate a charge corresponding to an incident light amount;
a switching unit configured to switch between a state in which the charge of the photoelectric converter is transferred to a charge retainer and a state in which the charge of the photoelectric converter is not transferred to the charge retainer;
a correction data generator configured to read a signal for each of the plurality of pixels from the charge retainer under a state of the charge of the photoelectric converter being not transferable to the charge retainer, to thereby generate noise correction data for each of the plurality of pixels; and
a pixel noise corrector configured to read the signal for each of the plurality of pixels from the charge retainer under a state of the charge of the photoelectric converter being transferrable to the charge retainer, to thereby correct noise for each of the plurality of pixels based on the noise correction data generated by the correction data generator.

2. The image pickup apparatus according to claim 1, wherein the correction data generator is further configured to generate the noise correction data for each of the plurality of pixels based on a plurality of signals acquired by reading the signal a plurality of times.

3. The image pickup apparatus according to claim 1, wherein the correction data generator is further configured to set a pixel of the plurality of pixels to be subjected to the signal reading for generating the noise correction data and a pixel of the plurality of pixels not to be subjected to the signal reading in an arbitrary region on the image pickup element.

4. The image pickup apparatus according to claim 1, further comprising a memory configured to store the signal read from the charge retainer for each of the plurality of pixels.

5. The image pickup apparatus according to claim 1, further comprising:
a light-blocking element configured to switch between a state of blocking light entering the image pickup element and a state of allowing the light to enter the image pickup element;
a light-blocking element controller configured to control driving of the light-blocking element; and
a dark image data generator configured to generate dark image data based on a signal read from the image pickup element under the state in which the light entering the image pickup element is blocked by the light-blocking element,
wherein the pixel noise corrector is further configured to correct the noise for each of the plurality of pixels based on the dark image data generated by the dark image data generator.

6. The image pickup apparatus according to claim 1, further comprising a lens apparatus,
wherein the image pickup element is further configured to receive light from the lens apparatus.

7. The image pickup apparatus according to claim 6, further comprising:
an output unit configured to generate an image based on the signal corrected by the pixel noise corrector, and output the image; and
a display configured to display the image that is based on the signal from the output unit.

8. The image pickup apparatus according to claim 1, wherein a lens apparatus that guides light from an object to the image pickup element is detachably attachable to the image pickup apparatus.
